(19) United States
(12) Patent Application Publication
(10) Pub. No.: US 2008/0012832 A1
(43) Pub. Date: Jan. 17, 2008

(54) Multi-function touchpad

(76) Inventor: Li GuangHai, Shanghai (CN)

Correspondence Address: Daniel E. Ovanezian;BLAKELY, SOKOLOFF, TAYLOR & ZAFMAN LLP, Seventh Floor, 12400 Wilshire Boulevard, Los Angeles, CA, 90025, US

(21) Appl. No.: 11/487,056

(22) Filed: Jul. 13, 2006

(51) Int. Cl. G06F 3/041

(52) U.S. Cl. 345/173

(57) ABSTRACT

A method and apparatus is disclosed herein for providing a touch-sensor device. In one embodiment, the method includes receiving absolute positioning data indicative of movement of a presence of a conductive object across a touch sensor pad in one of a plurality of directions relative to a function point. In one embodiment, the function point is at least one of a physical button or a virtual button of the touch sensor pad disposed in a region of the touch sensor pad configured to receive absolute positioning data. The method further includes processing a function when the movement accompanies detection of the conductive object at the function point.

### TECHNICAL FIELD

This invention relates to the field of user interface devices and, in particular, to touch-sensor devices.

### BACKGROUND

Computing devices, such as notebook computers, personal data assistants (PDAs), and mobile handsets, have user interface devices, which are also known as human interface device (HID). One user interface device that has become more common is a touch-sensor pad. A basic notebook touch-sensor pad emulates the function of a personal computer (PC) mouse. A touch-sensor pad is typically embedded into a PC notebook for built-in portability. A touch-sensor pad replicates mouse x/y movement by using two defined axes which contain a collection of sensor elements that detect the position of a conductive object, such as finger. Mouse right/left button clicks can be replicated by two mechanical buttons, located in the vicinity of the touchpad, or by tapping commands on the touch-sensor pad itself. The touch-sensor pad provides a user interface device for performing such functions as positioning a cursor, or selecting an item on a display. These touch-sensor pads can include multi-dimensional sensor arrays. The sensor array may be one dimensional, detecting movement in one axis. The sensor array may also be two dimensional, detecting movements in two axes.

FIG. 1A illustrates a conventional touch-sensor pad. The touch-sensor pad 100 includes a sensing surface 101 on which a conductive object may be used to position a cursor in the x- and y-axes. Touch-sensor pad 100 may also include two buttons, left and right buttons 102 and 103, respectively. These buttons are typically mechanical buttons, and operate much like a left and right button on a mouse. In some systems, these buttons may be touch-sensor buttons. These buttons permit a user to select items on a display or send other commands to the computing device.

FIG. 1B illustrates a conventional touch-sensor pad with a sub-region. The touch-sensor pad 150 includes a sub-region 152 defining an x-y region on which a conductive object may trigger a pre-defined function. When a conductive object contacts touch-sensor pad 150 at position x‘-y’, the touch-sensor pad 150 reports the position and a host processor (not-shown) compares x‘-y’ with the positions defined by the sub-region. If the conductive object is within the sub-region, the mapped function is triggered. Although not shown, touch-sensor pads, such as touch-sensor pad 150, often include several regions which may be utilized to trigger many functions.

One problem encountered with touch-sensor pad 150 is the consumption of space on the touch sensor pad needed to implement multiple functions associated with sub-regions of a touch-sensor pad. A touch-sensor pad's surface area for sensing a conductive object is finite. When a touch-sensor pad includes multiple sub regions dedicated to multiple functions, a touch sensor pad's sensing surface area is dramatically reduced.

### BRIEF DESCRIPTION OF THE DRAWINGS

The present invention is illustrated by way of example, and not by way of limitation, in the figures of the accompanying drawings.

FIG. 1A illustrates a conventional touch-sensor pad.

FIG. 1B illustrates a conventional touch-sensor pad including a predefined sub-region.

FIG. 2 illustrates a block diagram of one embodiment of an electronic system having a processing device for detecting presence of a conductive object.

FIG. 3A illustrates a varying switch capacitance.

FIG. 3B illustrates one embodiment of a relaxation oscillator.

FIG. 4 illustrates a block diagram of one embodiment of a capacitance sensor including a relaxation oscillator and digital counter.

FIG. 5A illustrates a top-side view of one embodiment of a two-layer touch-sensor pad.

FIG. 5B illustrates a side view of one embodiment of the two-layer touch-sensor pad of FIG. 5A.

FIG. 6 illustrates a top-side view of an embodiment of a touch-sensor device including a function point.

FIG. 7A illustrates an embodiment of a touch-sensor device including a function point.

FIG. 7B illustrates an embodiment of a touch-sensor device including a function point.

FIG. 7C illustrates an embodiment of a touch-sensor device including a point.

FIG. 8A illustrates one embodiment of a method for processing data from a touch-sensor device including a function point.

FIG. 8B illustrates one embodiment of a method for processing data from a touch-sensor device including a function point.

FIG. 8C illustrates one embodiment of a method for processing data from a touch-sensor device including a function point.

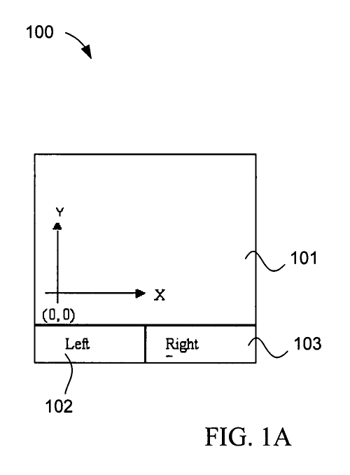

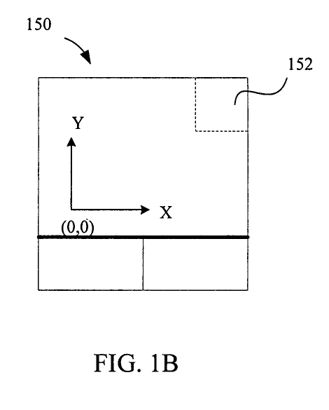

### DETAILED DESCRIPTION

The following detailed description includes circuits, which will be described below. Alternatively, the operations of the circuits may be performed by a combination of hardware, firmware, and software. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines, and each of the single signal lines may alternatively be buses.

A method and apparatus for a multi-function slider in a touchpad is described. In one embodiment, absolute positioning data is received which indicates movement of a conductive object across a touch sensor pad in one of a plurality of directions relative to a function point. The function point is at least one of a physical button or a virtual button of the touch sensor pad that is disposed in a region of the touch sensor pad configured to receive absolute positioning data. Then, in one embodiment, a function is processed when the movement accompanies detection of the conductive object at the function point.

In one embodiment, the function processed when the movement accompanies detection of the conductive object at the function point, further comprises detecting data indicative of a selection of the function point by a user. Then, after the data indicative of the selection by the user of the function point, absolute positioning data indicative of a movement of a presence of a conductive object is detected. In one embodiment, in which direction the movement was detected is determined and a function is processed based on the determined direction. In one embodiment, exemplary functions which may be processed when absolute positioning data is detected after detecting a user's selection of the function point include, but are not limited to, scroll functions and browser function.

In one embodiment, the function processed when the movement accompanies detection of the conductive object at the function point, further comprises detecting absolute positioning data indicative of a movement of a presence of a conductive object toward the function point of the touch sensor pad. After the data indicative of the movement is detected, data indicative of a selection by a user of the function point of the touch sensor pad is detected. In one embodiment, in which direction the movement was detected is determined and a function is processed based on the determined direction.

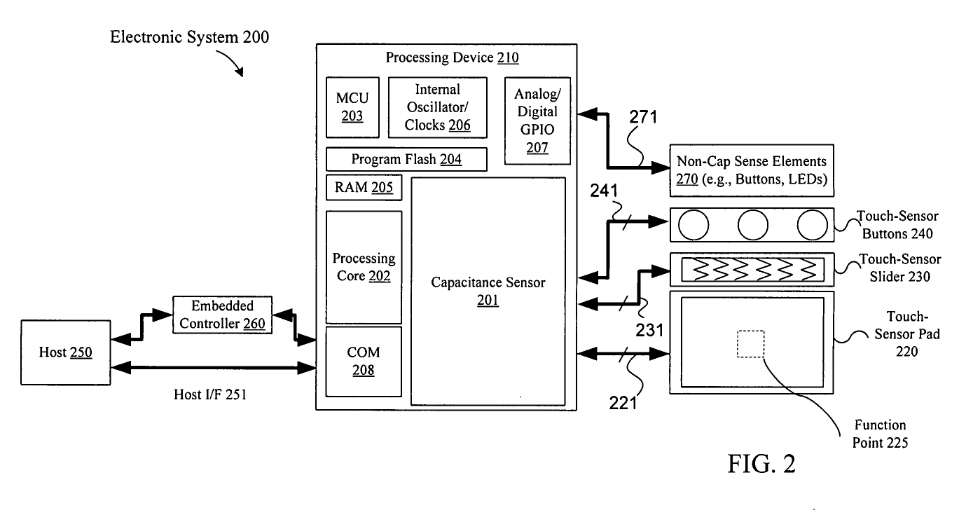

FIG. 2 illustrates a block diagram of one embodiment of an electronic system having a processing device for detecting presence of a conductive object. Electronic system 200 includes processing device 210, touch-sensor pad 220, touch-sensor slider 230, touch-sensor buttons 240, host processor 250, embedded controller 260, and non-capacitance sensor elements 270. The processing device 210 may include analog and/or digital general purpose input/output (“GPIO”) ports 207. GPIO ports 207 may be programmable. GPIO ports 207 may be coupled to a Programmable Interconnect and Logic (“PIL”), which acts as an interconnection between GPIO ports 207 and a digital block array of the processing device 210 (not illustrated). The digital block array may be configured to implement a variety of digital logic circuits (e.g., DAC, digital filters, digital control systems, etc.) using, in one embodiment, configurable user modules (“UMs”). The digital block array may be coupled to a system bus. Processing device 210 may also include memory, such as random access memory (RAM) 205 and program flash 204. RAM 205 may be static RAM (SRAM), and program flash 204 may be a non-volatile storage, which may be used to store firmware (e.g., control algorithms executable by processing core 202 to implement operations described herein). Processing device 210 may also include a memory controller unit (MCU) 203 coupled to memory and the processing core 202.

The processing device 210 may also include an analog block array (not illustrated). The analog block array is also coupled to the system bus. Analog block array also may be configured to implement a variety of analog circuits (e.g., ADC, analog filters, etc.) using configurable UMs. The analog block array may also be coupled to the GPIO 207.

As illustrated, capacitance sensor 201 may be integrated into processing device 210. Capacitance sensor 201 may include analog I/O for coupling to an external component, such as touch-sensor pad 220, touch-sensor slider 230, touch-sensor buttons 240, and/or other devices. Capacitance sensor 201 and processing device 210 are described in more detail below.

It should be noted that the embodiments described herein are not limited to touch-sensor pads for notebook implementations, but can be used in other capacitive sensing implementations, for example, a touch-slider 230 or touch-sensor buttons 240 (e.g., capacitance sensor button). Similarly, the operations described herein are not limited to notebook cursor operations, but can include other operations, such as lighting control (dimmer), volume control, graphic equalizer control, speed control, or other control operations requiring gradual adjustments. It should also be noted that these embodiments of capacitive sensing implementations may be used in conjunction with non-capacitive sensing elements 270, including but not limited to pick buttons, sliders (ex. display brightness and contrast), scroll-wheels, multi-media control (ex. volume, track advance, etc) handwriting recognition and numeric keypad operation.

In one embodiment, the electronic system 200 includes a touch-sensor pad 220 coupled to the processing device 210 via bus 221. Touch-sensor pad 220 may include a multi-dimension sensor array. The multi-dimension sensor array comprises a plurality of sensor elements, organized as rows and columns. In another embodiment, the electronic system 200 includes a touch-sensor slider 230 coupled to the processing device 210 via bus 231. Touch-sensor slider 230 may include a single-dimension sensor array. The single-dimension sensor array comprises a plurality of sensor elements, organized as rows, or alternatively, as columns. Whereas a touch-sensor pad 220 is a sensing device having a multiple row/column array of sensing elements, touch-sensor slider 230 is a one-dimensional touch sensing device. Touch-sensor slider 230 does not convey the absolute position of a conductive object (e.g., to emulate a mouse in controlling cursor positioning on a display), but, rather, used to actuate one or more functions associated with particular sensing elements of the touch-sensor slider 230.

In another embodiment, the electronic system 200 includes a touch-sensor button 240 coupled to the processing device 210 via bus 241. Touch-sensor button 240 may include a single-dimension or multi-dimension sensor array. The single- or multi-dimension sensor array comprises a plurality of sensor elements. For a touch-sensor button, the plurality of sensor elements may be coupled together to detect a presence of a conductive object over the entire surface of the sensing device. Capacitance sensor elements may be used as non-contact switches. These switches, when protected by an insulating layer, offer resistance to severe environments.

The electronic system 200 may include any combination of one or more of the touch-sensor pad 220, touch-sensor slider 230, and/or touch-sensor button 240. In another embodiment, the electronic system 200 may also include non-capacitance sensor elements 270 coupled to the processing device 210 via bus 271. The non-capacitance sensor elements 270 may include buttons, light emitting diodes (LEDs), and other user interface devices, such as a mouse, a keyboard, or other functional keys that do not require capacitance sensing. In one embodiment, buses 271, 241, 231, and 221 may be a single bus. Alternatively, these buses may be configured into any combination of one or more separate buses.

In one embodiment, a touch-sensor pad 220 includes a function point 225 of touch-sensor pad 220 disposed in a region of touch-sensor pad 220 configured to receive absolute positioning data. As will be discussed in greater detail below, function point 225 is utilized by any of processing device 210, embedded controller 260, or host 250, to support a multi-function touch-sensor pad. In one embodiment, function point 225 may be a touch-sensor button 240 within touch-sensor pad 220 comprising a plurality of touch sensor elements of touch sensor pad 220. The touch-sensor elements corresponding to function point 225 may be determined by processing device 210 based on an x-y coordinate of the sensor element. Thus, a bounded area within touch-sensor pad 220, defined in both the x- and y-directions, represents the area defining a function point 225. Although function point 225 is illustrated as a square, any shape may be used to create a bounded area for a function point on a touch sensor pad, including but not limited to, a circle, a rectangle, an oval, or any other bounded shape. In one embodiment, instead of a touch-sensor button, function point 225 may be a non-capacitance sensor button (i.e., a physical button) within touch sensor pad 220, such as non-cap sense button element 270. In yet another embodiment, function point 225 is both a cap-sense button 240 and a non-cap sense button 270 within touch sensor pad 220. In any of the above noted embodiments of function point 225, the area corresponding to function point 225 on touch-sensor pad 220 may be visually and/or physically distinguished on touch sensor pad 220, such as by raising an edge on the surface of touch sensor pad 220 around an area defining a function point, thereby providing a graphical and visual cue as the location of function point 225.

The processing device may also provide value-add functionality such as keyboard control integration, LEDs, battery charger and general purpose I/O, as illustrated as non-capacitance sensor elements 270. Non-capacitance sensor elements 270 are coupled to the GPIO 207.

Processing device 210 may include internal oscillator/clocks 206, and communication block 208. The oscillator/clocks block 206 provides clock signals to one or more of the components of processing device 210. Communication block 208 may be used to communicate with an external component, such as a host processor 250, via host interface (I/F) line 251. Alternatively, processing block 210 may also be coupled to embedded controller 260 to communicate with the external components, such as host 250. Interfacing to the host 250 can be through various methods. In one exemplary embodiment, interfacing with the host 250 may be done using a standard PS/2 interface to connect to an embedded controller 260, which in turn sends data to the host 250 via low pin count (LPC) interface. In some instances, it may be beneficial for the processing device 210 to do both touch-sensor pad and keyboard control operations, thereby freeing up the embedded controller 260 for other housekeeping functions. In another exemplary embodiment, interfacing may be done using a universal serial bus (USB) interface directly coupled to the host 250 via host interface line 251. Alternatively, the processing device 210 may communicate to external components, such as the host 250 using industry standard interfaces, such as USB, PS/2, inter-integrated circuit (I2C) bus, or system packet interface (SPI). The embedded controller 260 and/or embedded controller 260 may be coupled to the processing device 210 with a ribbon or flex cable from an assembly, which houses the touch-sensor pad and processing device.

In one embodiment, the processing device 210 is configured to communicate with the embedded controller 260 or the host 250 to send and/or receive data. The data may be a command or alternatively a signal. In an exemplary embodiment, the electronic system 200 may operate in both standard-mouse compatible and enhanced modes. The standard-mouse compatible mode utilizes the HID class drivers already built into the Operating System (OS) software of host 250. These drivers enable the processing device 210 and sensing device to operate as a standard cursor control user interface device, such as a two-button PS/2 mouse. The enhanced mode may enable additional features such as scrolling (reporting absolute position) or disabling the sensing device, such as when a mouse is plugged into the notebook. Alternatively, the processing device 210 may be configured to communicate with the embedded controller 260 or the host 250, using non-OS drivers, such as dedicated touch-sensor pad drivers, or other drivers known by those of ordinary skill in the art.

In other words, the processing device 210 may operate to communicate data (e.g., commands or signals) using hardware, software, and/or firmware, and the data may be communicated directly to the processing device of the host 250, such as a host processor, or alternatively, may be communicated to the host 250 via drivers of the host 250, such as OS drivers, or other non-OS drivers. It should also be noted that the host 250 may directly communicate with the processing device 210 via host interface 251.

In one embodiment, the data sent to the host 250 from the processing device 210 includes click, double-click, movement of the cursor, etc. Alternatively, other user interface device commands may be communicated to the host 250 from the processing device 210. These commands may be based on gestures occurring on the sensing device that are recognized by the processing device, such as tap, push, hop, and zigzag gestures. Alternatively, other commands may be recognized. Similarly, signals may be sent that indicate the recognition of these operations.

In particular, a tap gesture, for example, may be when the finger (e.g., conductive object) is on the sensing device for less than a threshold time. If the time the finger is placed on the touchpad is greater than the threshold time it may be considered to be a movement of the cursor, in the x- or y-axes. Scroll-up, scroll-down, scroll-left, and scroll-right, step back, and step-forward may be detected when the absolute position of the conductive object is within a pre-defined area, and movement of the conductive object is detected.

Processing device 210 may reside on a common carrier substrate such as, for example, an integrated circuit (IC) die substrate, a multi-chip module substrate, or the like. Alternatively, the components of processing device 210 may be one or more separate integrated circuits and/or discrete components. In one exemplary embodiment, processing device 210 may be a Programmable System on a Chip (PSoC™) processing device, manufactured by Cypress Semiconductor Corporation, San Jose, Calif. Alternatively, processing device 210 may be other one or more processing devices known by those of ordinary skill in the art, such as a microprocessor or central processing unit, a controller, special-purpose processor, digital signal processor (DSP), an application specific integrated circuit (ASIC), a field programmable gate array (FPGA), or the like. In an alternative embodiment, for example, the processing device may be a network processor having multiple processors including a core unit and multiple microengines. Additionally, the processing device may include any combination of general-purpose processing device(s) and special-purpose processing device(s).

Capacitance sensor 201 may be integrated into the IC of the processing device 210, or alternatively, in a separate IC. Alternatively, descriptions of capacitance sensor 201 may be generated and compiled for incorporation into other integrated circuits. For example, behavioral level code describing capacitance sensor 201, or portions thereof, may be generated using a hardware descriptive language, such as VHDL or Verilog, and stored to a machine-accessible medium (e.g., CD-ROM, hard disk, floppy disk, etc.). Furthermore, the behavioral level code can be compiled into register transfer level (“RTL”) code, a netlist, or even a circuit layout and stored to a machine-accessible medium. The behavioral level code, the RTL code, the netlist, and the circuit layout all represent various levels of abstraction to describe capacitance sensor 201.

It should be noted that the components of electronic system 200 may include all the components described above. Alternatively, electronic system 200 may include only some of the components described above.

In one embodiment, electronic system 200 may be used in a notebook computer. Alternatively, the electronic device may be used in other applications, such as a mobile handset, a personal data assistant (PDA), a keyboard, a television, a remote control, a monitor, a handheld multi-media device, a handheld video player, a handheld gaming device, or a control panel.

In one embodiment, capacitance sensor 201 may be a capacitive switch relaxation oscillator (CSR). The CSR may have an array of capacitive touch switches using a current-programmable relaxation oscillator, an analog multiplexer, digital counting functions, and high-level software routines to compensate for environmental and physical switch variations. The switch array may include combinations of independent switches, sliding switches (e.g., touch-sensor slider), and touch-sensor pads implemented as a pair of orthogonal sliding switches. The CSR may include physical, electrical, and software components. The physical component may include the physical switch itself, typically a pattern constructed on a printed circuit board (PCB) with an insulating cover, a flexible membrane, or a transparent overlay. The electrical component may include an oscillator or other means to convert a changed capacitance into a measured signal. The electrical component may also include a counter or timer to measure the oscillator output. The software component may include detection and compensation software algorithms to convert the count value into a switch detection decision. For example, in the case of slide switches or X-Y touch-sensor pads, a calculation for finding position of the conductive object to greater resolution than the physical pitch of the switches may be used.

It should be noted that there are various known methods for measuring capacitance. Although the embodiments described herein are described using a relaxation oscillator, the present embodiments are not limited to using relaxation oscillators, but may include other methods, such as current versus voltage phase shift measurement, resistor-capacitor charge timing, capacitive bridge divider or, charge transfer.

The current versus voltage phase shift measurement may include driving the capacitance through a fixed-value resistor to yield voltage and current waveforms that are out of phase by a predictable amount. The drive frequency can be adjusted to keep the phase measurement in a readily measured range. The resistor-capacitor charge timing may include charging the capacitor through a fixed resistor and measuring timing on the voltage ramp. Small capacitor values may require very large resistors for reasonable timing. The capacitive bridge divider may include driving the capacitor under test through a fixed reference capacitor. The reference capacitor and the capacitor under test form a voltage divider. The voltage signal is recovered with a synchronous demodulator, which may be done in the processing device 210. The charge transfer may be conceptually similar to an R-C charging circuit. In this method, Cₚ is the capacitance being sensed. C_{SUM} is the summing capacitor, into which charge is transferred on successive cycles. At the start of the measurement cycle, the voltage on C_{SUM} is reset. The voltage on C_{SUM} increases exponentially (and only slightly) with each clock cycle. The time for this voltage to reach a specific threshold is measured with a counter. Additional details regarding these alternative embodiments have not been included so as to not obscure the present embodiments, and because these alternative embodiments for measuring capacitance are known by those of ordinary skill in the art.

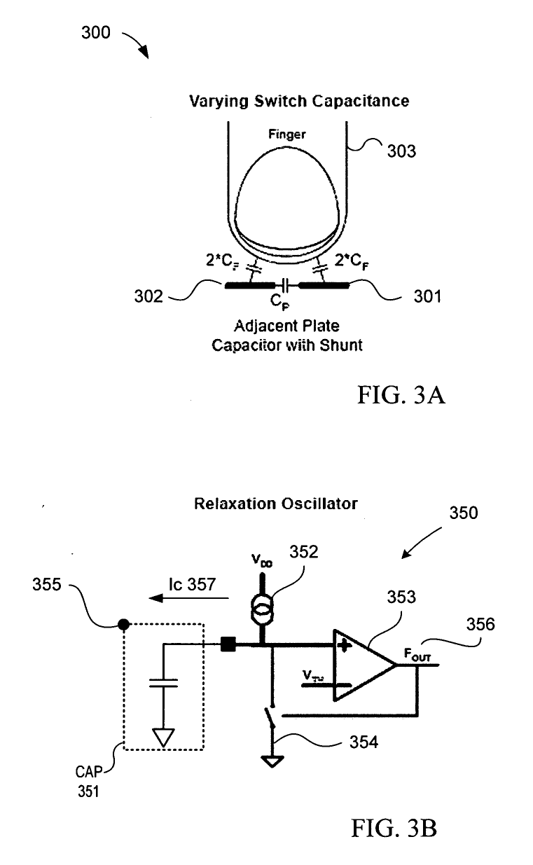

FIG. 3A illustrates a varying switch capacitance. In its basic form, a capacitive switch 300 is a pair of adjacent plates 301 and 302. There is a small edge-to-edge capacitance Cp, but the intent of switch layout is to minimize the base capacitance Cp between these plates. When a conductive object 303 (e.g., finger) is placed in proximity to the two plate 301 and 302, there is a capacitance 2*Cf between one electrode 301 and the conductive object 303 and a similar capacitance 2*Cf between the conductive object 303 and the other electrode 302. The capacitance between one electrode 301 and the conductive object 303 and back to the other electrode 302 adds in parallel to the base capacitance Cp between the plates 301 and 302, resulting in a change of capacitance Cf. Capacitive switch 300 may be used in a capacitance switch array. The capacitance switch array is a set of capacitors where one side of each is grounded. Thus, the active capacitor (as represented in FIG. 3B as capacitor 351) has only one accessible side. The presence of the conductive object 303 increases the capacitance (Cp+Cf) of the switch 300 to ground. Determining switch activation is then a matter of measuring change in the capacitance (Cf). Switch 300 is also known as a grounded variable capacitor. In one exemplary embodiment, Cf may range from approximately 10-30 picofarads (pF). Alternatively, other ranges may be used.

The conductive object in this case is a finger, alternatively, this technique may be applied to any conductive object, for example, a conductive door switch, position sensor, or conductive pen in a stylus tracking system.

FIG. 3B illustrates one embodiment of a relaxation oscillator. The relaxation oscillator 350 is formed by the capacitance to be measured on capacitor 351, a charging current source 352, a comparator 353, and a reset switch 354. It should be noted that capacitor 351 is representative of the capacitance measured on a sensor element of a sensor array. The relaxation oscillator is coupled to drive a charging current (Ic) 357 in a single direction onto a device under test (“DUT”) capacitor, capacitor 351. As the charging current piles charge onto the capacitor 351, the voltage across the capacitor increases with time as a function of Ic 357 and its capacitance C. Equation (1) describes the relation between current, capacitance, voltage and time for a charging capacitor.

CdV=I_{c}dt (1)

The relaxation oscillator begins by charging the capacitor 351 from a ground potential or zero voltage and continues to pile charge on the capacitor 351 at a fixed charging current Ic 357 until the voltage across the capacitor 351 at node 355 reaches a reference voltage or threshold voltage, V_{TH} 355. At V_{TH} 355, the relaxation oscillator allows the accumulated charge at node 355 to discharge (e.g., the capacitor 351 to “relax” back to the ground potential) and then the process repeats itself. In particular, the output of comparator 353 asserts a clock signal F_{OUT} 356 (e.g., F_{OUT} 356 goes high), which enables the reset switch 354. This resets the voltage on the capacitor at node 355 to ground and the charge cycle starts again. The relaxation oscillator outputs a relaxation oscillator clock signal (F_{OUT} 356) having a frequency (f_{RO}) dependent upon capacitance C of the capacitor 351 and charging current Ic 357.

The comparator trip time of the comparator 353 and reset switch 354 add a fixed delay. The output of the comparator 353 is synchronized with a reference system clock to guarantee that the comparator reset time is long enough to completely reset the charging voltage on capacitor 355. This sets a practical upper limit to the operating frequency. For example, if capacitance C of the capacitor 351 changes, then f_{RO} will change proportionally according to Equation (1). By comparing f_{RO} of F_{OUT} 356 against the frequency (f_{REF}) of a known reference system clock signal (REF CLK), the change in capacitance ΔC can be measured. Accordingly, equations (2) and (3) below describe that a change in frequency between F_{OUT} 356 and REF CLK is proportional to a change in capacitance of the capacitor 351.

ΔC∝Δf, where (2)

Δf=f_{RO}−f_{REF}. (3)

In one embodiment, a frequency comparator may be coupled to receive relaxation oscillator clock signal (F_{OUT} 356) and REF CLK, compare their frequencies f_{RO} and f_{REF}, respectively, and output a signal indicative of the difference Δf between these frequencies. By monitoring Δf one can determine whether the capacitance of the capacitor 351 has changed.

In one exemplary embodiment, the relaxation oscillator 350 may be built using a 555 timer to implement the comparator 353 and reset switch 354. Alternatively, the relaxation oscillator 350 may be built using other circuiting. Relaxation oscillators are known in by those of ordinary skill in the art, and accordingly, additional details regarding their operation have not been included so as to not obscure the present embodiments.

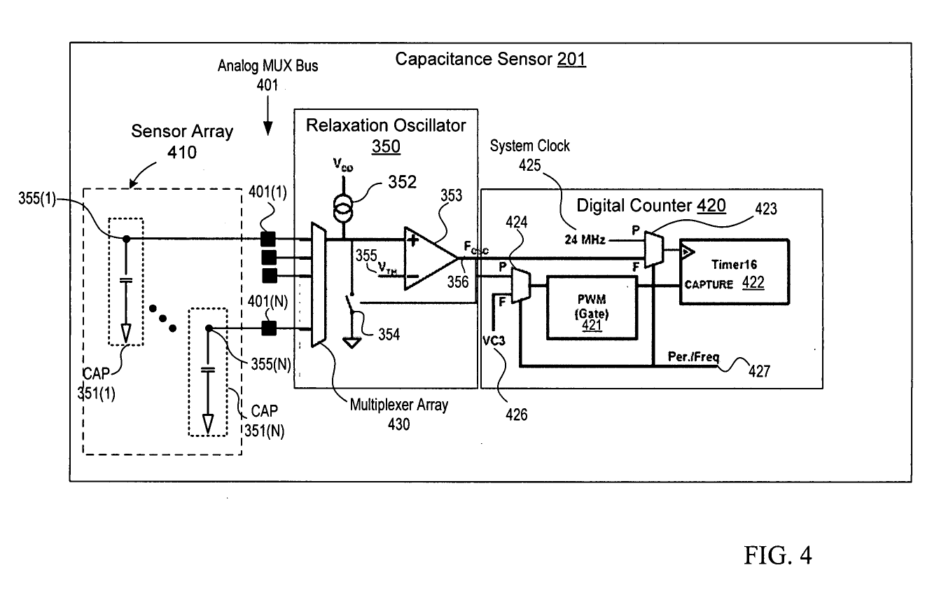

FIG. 4 illustrates a block diagram of one embodiment of a capacitance sensor including a relaxation oscillator and digital counter. Capacitance sensor 201 of FIG. 4 includes a sensor array 410 (also known as a switch array), relaxation oscillator 350, and a digital counter 420. Sensor array 410 includes a plurality of sensor elements 355(1)-355(N), where N is a positive integer value that represents the number of rows (or alternatively columns) of the sensor array 410. Each sensor element is represented as a capacitor, as previously described with respect to FIG. 3B. The sensor array 410 is coupled to relaxation oscillator 350 via an analog bus 401 having a plurality of pins 401(1)-401(N). In one embodiment, the sensor array 410 may be a single-dimension sensor array including the sensor elements 355(1)-355(N), where N is a positive integer value that represents the number of sensor elements of the single-dimension sensor array. The single-dimension sensor array 410 provides output data to the analog bus 401 of the processing device 210 (e.g., via lines 231). Alternatively, the sensor array 410 may be a multi-dimension sensor array including the sensor elements 355(1)-355(N), where N is a positive integer value that represents the number of sensor elements of the multi-dimension sensor array. The multi-dimension sensor array 410 provides output data to the analog bus 401 of the processing device 210 (e.g., via bus 221).

Relaxation oscillator 350 of FIG. 4 includes all the components described with respect to FIG. 3B, and a selection circuit 430. The selection circuit 430 is coupled to the plurality of sensor elements 355(1)-355(N), the reset switch 354, the current source 352, and the comparator 353. Selection circuit 430 may be used to allow the relaxation oscillator 350 to measure capacitance on multiple sensor elements (e.g., rows or columns). The selection circuit 430 may be configured to sequentially select a sensor element of the plurality of sensor elements to provide the charge current and to measure the capacitance of each sensor element. In one exemplary embodiment, the selection circuit 430 is a multiplexer array of the relaxation oscillator 350. Alternatively, selection circuit may be other circuitry outside the relaxation oscillator 350, or even outside the capacitance sensor 201 to select the sensor element to be measured. Capacitance sensor 201 may include one relaxation oscillator and digital counter for the plurality of sensor elements of the sensor array. Alternatively, capacitance sensor 201 may include multiple relaxation oscillators and digital counters to measure capacitance on the plurality of sensor elements of the sensor array. The multiplexer array may also be used to ground the sensor elements that are not being measured. This may be done in conjunction with a dedicated pin in the GP10 port 207.

In another embodiment, the capacitance sensor 201 may be configured to simultaneously scan the sensor elements, as opposed to being configured to sequentially scan the sensor elements as described above. For example, the sensing device may include a sensor array having a plurality of rows and columns. The rows may be scanned simultaneously, and the columns may be scanned simultaneously.

In one exemplary embodiment, the voltages on all of the rows of the sensor array are simultaneously moved, while the voltages of the columns are held at a constant voltage, with the complete set of sampled points simultaneously giving a profile of the conductive object in a first dimension. Next, the voltages on all of the rows are held at a constant voltage, while the voltages on all the rows are simultaneously moved, to obtain a complete set of sampled points simultaneously giving a profile of the conductive object in the other dimension.

In another exemplary embodiment, the voltages on all of the rows of the sensor array are simultaneously moved in a positive direction, while the voltages of the columns are moved in a negative direction. Next, the voltages on all of the rows of the sensor array are simultaneously moved in a negative direction, while the voltages of the columns are moved in a positive direction. This technique doubles the effect of any transcapacitance between the two dimensions, or conversely, halves the effect of any parasitic capacitance to the ground. In both methods, the capacitive information from the sensing process provides a profile of the presence of the conductive object to the sensing device in each dimension. Alternatively, other methods for scanning known by those of ordinary skill in the art may be used to scan the sensing device.

Digital counter 420 is coupled to the output of the relaxation oscillator 350. Digital counter 420 receives the relaxation oscillator output signal 356 (F_{OUT}). Digital counter 420 is configured to count at least one of a frequency or a period of the relaxation oscillator output received from the relaxation oscillator.

As previously described with respect to the relaxation oscillator 350, when a finger or conductive object is placed on the switch, the capacitance increases from Cp to Cp+Cf so the relaxation oscillator output signal 356 (F_{OUT}) decreases. The relaxation oscillator output signal 356 (F_{OUT}) is fed to the digital counter 420 for measurement. There are two methods for counting the relaxation oscillator output signal 356, frequency measurement and period measurement. In one embodiment, the digital counter 420 may include two multiplexers 423 and 424. Multiplexers 423 and 424 are configured to select the inputs for the PWM 421 and the timer 422 for the two measurement methods, frequency and period measurement methods. Alternatively, other selection circuits may be used to select the inputs for the PWM 421 and the time 422. In another embodiment, multiplexers 423 and 424 are not included in the digital counter, for example, the digital counter 420 may be configured in one, or the other, measurement configuration.

In the frequency measurement method, the relaxation oscillator output signal 356 is counted for a fixed period of time. The counter 422 is read to obtain the number of counts during the gate time. This method works well at low frequencies where the oscillator reset time is small compared to the oscillator period. A pulse width modulator (PWM) 441 is clocked for a fixed period by a derivative of the system clock, VC3 426 (which is a divider from the 24 MHz system clock 425). Pulse width modulation is a modulation technique that generates variable-length pulses to represent the amplitude of an analog input signal; in this case VC3 426. The output of PWM 421 enables timer 422 (e.g., 16-bit). The relaxation oscillator output signal 356 clocks the timer 422. The timer 422 is reset at the start of the sequence, and the count value is read out at the end of the gate period.

In the period measurement method, the relaxation oscillator output signal 356 gates a counter 422, which is clocked by the system clock 425 (e.g., 24 MHz). In order to improve sensitivity and resolution, multiple periods of the oscillator are counted with the PWM 421. The output of PWM 421 is used to gate the timer 422. In this method, the relaxation oscillator output signal 356 drives the clock input of PWM 421. As previously described, pulse width modulation is a modulation technique that generates variable-length pulses to represent the amplitude of an analog input signal; in this case the relaxation oscillator output signal 356. The output of the PWM 421 enables a timer 422 (e.g., 16-bit), which is clocked at the system clock frequency 425 (e.g., 24 MHz). When the output of PWM 421 is asserted (e.g., goes high), the count starts by releasing the capture control. When the terminal count of the PWM 421 is reached, the capture signal is asserted (e.g., goes high), stopping the count and setting the PWM's interrupt. The timer value is read in this interrupt. The relaxation oscillator 350 is indexed to the next switch (e.g., capacitor 351(2)) to be measured and the count sequence is started again.

The two counting methods may have equivalent performance in sensitivity and signal-to-noise ratio (SNR). The period measurement method may have a slightly faster data acquisition rate, but this rate is dependent on software load and the values of the switch capacitances. The frequency measurement method has a fixed-switch data acquisition rate.

The length of the counter 422 and the detection time required for the switch are determined by sensitivity requirements. Small changes in the capacitance on capacitor 351 result in small changes in frequency. In order to find these small changes, it may be necessary to count for a considerable time.

At startup (or boot) the switches (e.g., capacitors 351(1)-(N)) are scanned and the count values for each switch with no actuation are stored as a baseline array (Cp). The presence of a finger on the switch is determined by the difference in counts between a stored value for no switch actuation and the acquired value with switch actuation, referred to here as Δn. The sensitivity of a single switch is approximately:

$$\frac{Δ n}{n} = \frac{Cf}{Cp} \qquad ( 4 )$$

The value of Δn should be large enough for reasonable resolution and clear indication of switch actuation. This drives switch construction decisions.

Cf should be as large a fraction of Cp as possible. In one exemplary embodiment, the fraction of Cf/Cp ranges between approximately 0.01 to approximately 2.0. Alternatively, other fractions may be used for Cf/Cp. Since Cf is determined by finger area and distance from the finger to the switch's conductive traces (through the over-lying insulator), the baseline capacitance Cp should be minimized. The baseline capacitance Cp includes the capacitance of the switch pad plus any parasitics, including routing and chip pin capacitance.

In switch array applications, variations in sensitivity should be minimized. If there are large differences in Δn, one switch may actuate at 1.0 cm, while another may not actuate until direct contact. This presents a non-ideal user interface device. There are numerous methods for balancing the sensitivity. These may include precisely matching on-board capacitance with PC trace length modification, adding balance capacitors on each switch's PC board trace, and/or adapting a calibration factor to each switch to be applied each time the switch is tested.

In one embodiment, the PCB design may be adapted to minimize capacitance, including thicker PCBs where possible. In one exemplary embodiment, a 0.062 inch thick PCB is used. Alternatively, other thicknesses may be used, for example, a 0.015 inch thick PCB.

It should be noted that the count window should be long enough for Δn to be a “significant number.” In one embodiment, the “significant number” can be as little as 10, or alternatively, as much as several hundred. In one exemplary embodiment, where Cf is 1.0% of Cp (a typical “weak” switch), and where the switch threshold is set at a count value of 20, n is found to be:

$$n = Δ n \cdot \frac{Cf}{Cp} = 2000 \qquad ( 5 )$$

Adding some margin to yield 2500 counts, and running the frequency measurement method at 1.0 MHz, the detection time for the switch is 4 microseconds. In the frequency measurement method, the frequency difference between a switch with and without actuation (i.e., CP+CF vs. CP) is approximately:

$$Δ n = \frac{{t}_{count} \cdot {i}_{c}}{{V}_{TH}} \frac{Cf}{{Cp}^{2}} \qquad ( 6 )$$

This shows that the sensitivity variation between one channel and another is a function of the square of the difference in the two channels' static capacitances. This sensitivity difference can be compensated using routines in the high-level Application Programming Interfaces (APIs).

In the period measurement method, the count difference between a switch with and without actuation (i.e., CP+CF vs. CP) is approximately:

$$Δ n = {N}_{Periods} \cdot \frac{Cf \cdot {V}_{TH}}{{i}_{C}} \cdot {f}_{SysClk} \qquad ( 7 )$$

The charge currents are typically lower and the period is longer to increase sensitivity, or the number of periods for which f_{SysClk} is counted can be increased. In either method, by matching the static (parasitic) capacitances Cp of the individual switches, the repeatability of detection increases, making all switches work at the same difference. Compensation for this variation can be done in software at runtime. The compensation algorithms for both the frequency method and period method may be included in the high-level APIs.

Some implementations of this circuit use a current source programmed by a fixed-resistor value. If the range of capacitance to be measured changes, external components, (i.e., the resistor) should be adjusted.

Using the multiplexer array 430, multiple sensor elements may be sequentially scanned to provide current to and measure the capacitance from the capacitors (e.g., sensor elements), as previously described. In other words, while one sensor element is being measured, the remaining sensor elements are grounded using the GPIO port 207. This drive and multiplex arrangement bypasses the existing GPIO to connect the selected pin to an internal analog multiplexer (mux) bus. The capacitor charging current (e.g., current source 352) and reset switch 353 are connected to the analog mux bus. This may limit the pin-count requirement to simply the number of switches (e.g., capacitors 351(1)-351(N)) to be addressed. In one exemplary embodiment, no external resistors or capacitors are required inside or outside the processing device 210 to enable operation.

The capacitor charging current for the relaxation oscillator 350 is generated in a register programmable current output DAC (also known as IDAC). Accordingly, the current source 352 is a current DAC or IDAC. The IDAC output current may be set by an 8-bit value provided by the processing device 210, such as from the processing core 202. The 8-bit value may be stored in a register or in memory.

Estimating and measuring PCB capacitances may be difficult; the oscillator-reset time may add to the oscillator period (especially at higher frequencies); and there may be some variation to the magnitude of the IDAC output current with operating frequency. Accordingly, the optimum oscillation frequency and operating current for a particular switch array may be determined to some degree by experimentation.

In many capacitive switch designs the two “plates” (e.g., 301 and 302) of the sensing capacitor are actually adjacent PCB pads or traces, as indicated in FIG. 3A. Typically, one of these plates is grounded. Layouts for touch-sensor slider (e.g., linear slide switches) and touch-sensor pad applications have switches that are immediately adjacent. In this case, all of the switches that are not active are grounded through the GPIO 207 of the processing device 210 dedicated to that pin. The actual capacitance between adjacent plates is small (Cp), but the capacitance of the active plate (and its PCB trace back to the processing device 210) to ground, when detecting the presence of the conductive object 303, may be considerably higher (Cp+Cf). The capacitance of two parallel plates is given by the following equation:

$$C = {ɛ}_{0} \cdot {ɛ}_{R} \cdot \frac{A}{d} = {ɛ}_{R} \cdot 8.85 \cdot \frac{A}{d} pF \text{/} \text{m} \qquad ( 8 )$$

The dimensions of equation (8) are in meters. This is a very simple model of the capacitance. The reality is that there are fringing effects that substantially increase the switch-to-ground (and PCB trace-to-ground) capacitance.

Switch sensitivity (i.e., actuation distance) may be increased by one or more of the following: 1) increasing board thickness to increase the distance between the active switch and any parasitics; 2) minimizing PC trace routing underneath switches; 3) utilizing a grided ground with 50% or less fill if use of a ground plane is absolutely necessary; 4) increasing the spacing between switch pads and any adjacent ground plane; 5) increasing pad area; 6) decreasing thickness of any insulating overlay; or 7) verifying that there is no air-gap between the PC pad surface and the touching finger.

There is some variation of switch sensitivity as a result of environmental factors. A baseline update routine, which compensates for this variation, may be provided in the high-level APIs.

Sliding switches are used for control requiring gradual adjustments. Examples include a lighting control (dimmer), volume control, graphic equalizer, and speed control. These switches are mechanically adjacent to one another. Actuation of one switch results in partial actuation of physically adjacent switches. The actual position in the sliding switch is found by computing the centroid location of the set of switches activated.

In applications for touch-sensor sliders (e.g., sliding switches) and touch-sensor pads it is often necessary to determine finger (or other capacitive object) position to more resolution than the native pitch of the individual switches. The contact area of a finger on a sliding switch or a touch-pad is often larger than any single switch. In one embodiment, in order to calculate the interpolated position using a centroid, the array is first scanned to verify that a given switch location is valid. The requirement is for some number of adjacent switch signals to be above a noise threshold. When the strongest signal is found, this signal and those immediately adjacent are used to compute a centroid:

$$\text{Centroid} = \frac{{n}_{i - 1} \cdot ( i - 1 ) + {n}_{i} i + {n}_{i + 1} \cdot ( i + 1 )}{{n}_{i - 1} + {n}_{i} i + {n}_{i + 1}} \qquad ( 9 )$$

The calculated value will almost certainly be fractional. In order to report the centroid to a specific resolution, for example a range of 0 to 100 for 12 switches, the centroid value may be multiplied by a calculated scalar. It may be more efficient to combine the interpolation and scaling operations into a single calculation and report this result directly in the desired scale. This may be handled in the high-level APIs. Alternatively, other methods may be used to interpolate the position of the conductive object.

A physical touchpad assembly is a multi-layered module to detect a conductive object. In one embodiment, the multi-layer stack-up of a touchpad assembly includes a PCB, an adhesive layer, and an overlay. The PCB includes the processing device 210 and other components, such as the connector to the host 250, necessary for operations for sensing the capacitance. These components are on the non-sensing side of the PCB. The PCB also includes the sensor array on the opposite side, the sensing side of the PCB. Alternatively, other multi-layer stack-ups may be used in the touchpad assembly.

The PCB may be made of standard materials, such as FR4 or Kapton™ (e.g., flexible PCB). In either case, the processing device 210 may be attached (e.g., soldered) directly to the sensing PCB (e.g., attached to the non-sensing side of the PCB). The PCB thickness varies depending on multiple variables, including height restrictions and sensitivity requirements. In one embodiment, the PCB thickness is at least approximately 0.3 millimeters (mm). Alternatively, the PCB may have other thicknesses. It should be noted that thicker PCBs may yield better results. The PCB length and width is dependent on individual design requirements for the device on which the sensing device is mounted, such as a notebook or mobile handset.

The adhesive layer is directly on top of the PCB sensing array and is used to affix the overlay to the overall touchpad assembly. Typical material used for connecting the overlay to the PCB is non-conductive adhesive such as 3M 467 or 468. In one exemplary embodiment, the adhesive thickness is approximately 0.05 mm. Alternatively, other thicknesses may be used.

The overlay may be non-conductive material used to protect the PCB circuitry to environmental elements and to insulate the user's finger (e.g., conductive object) from the circuitry. Overlay can be ABS plastic, polycarbonate, glass, or Mylar™. Alternatively, other materials known by those of ordinary skill in the art may be used. In one exemplary embodiment, the overlay has a thickness of approximately 1.0 mm. In another exemplary embodiment, the overlay thickness has a thickness of approximately 2.0 mm. Alternatively, other thicknesses may be used.

The sensor array may be a grid-like pattern of sensor elements (e.g., capacitive elements) used in conjunction with the processing device 210 to detect a presence of a conductive object, such as finger, to a resolution greater than that which is native. The touch-sensor pad layout pattern maximizes the area covered by conductive material, such as copper, in relation to spaces necessary to define the rows and columns of the sensor array.

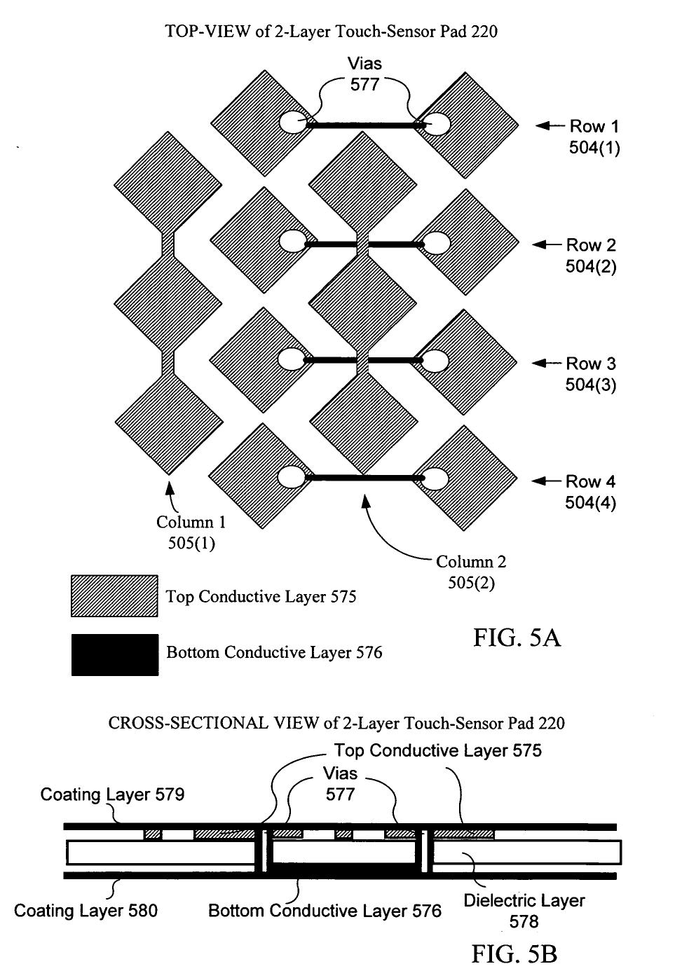

FIGS. 5A and 5B illustrate top-side and side views of one embodiment of a two-layer touch-sensor pad. Touch-sensor pad, as illustrated in FIGS. 5A and 5B, include the first two columns 505(1) and 505(2), and the first four rows 504(1)-504(4) of sensor array 500. The sensor elements of the first column 501(1) are connected together in the top conductive layer 575, illustrated as hashed diamond sensor elements and connections. The diamond sensor elements of each column, in effect, form a chain of elements. The sensor elements of the second column 501(2) are similarly connected in the top conductive layer 575. The sensor elements of the first row 504(1) are connected together in the bottom conductive layer 575 using vias 577, illustrated as black diamond sensor elements and connections. The diamond sensor elements of each row, in effect, form a chain of elements. The sensor elements of the second, third, and fourth rows 504(2)-504(4) are similarly connected in the bottom conductive layer 576.

As illustrated in FIG. 5B, the top conductive layer 575 includes the sensor elements for both the columns and the rows of the sensor array, as well as the connections between the sensor elements of the columns of the sensor array. The bottom conductive layer 576 includes the conductive paths that connect the sensor elements of the rows that reside in the top conductive layer 575. The conductive paths between the sensor elements of the rows use vias 577 to connect to one another in the bottom conductive layer 576. Vias 577 go from the top conductive layer 575, through the dielectric layer 578, to the bottom conductive layer 576. Coating layers 579 and 589 are applied to the surfaces opposite to the surfaces that are coupled to the dielectric layer 578 on both the top and bottom conductive layers 575 and 576.

It should be noted that the present embodiments should not be limited to connecting the sensor elements of the rows using vias to the bottom conductive layer 576, but may include connecting the sensor elements of the columns using vias to the bottom conductive layer 576.

When pins are not being sensed (only one pin is sensed at a time), they are routed to ground. By surrounding the sensing device (e.g., touch-sensor pad) with a ground plane, the exterior elements have the same fringe capacitance to ground as the interior elements.

In one embodiment, an IC including the processing device 210 may be directly placed on the non-sensor side of the PCB. This placement does not necessary have to be in the center. The processing device IC is not required to have a specific set of dimensions for a touch-sensor pad, nor a certain number of pins. Alternatively, the IC may be placed somewhere external to the PCB.

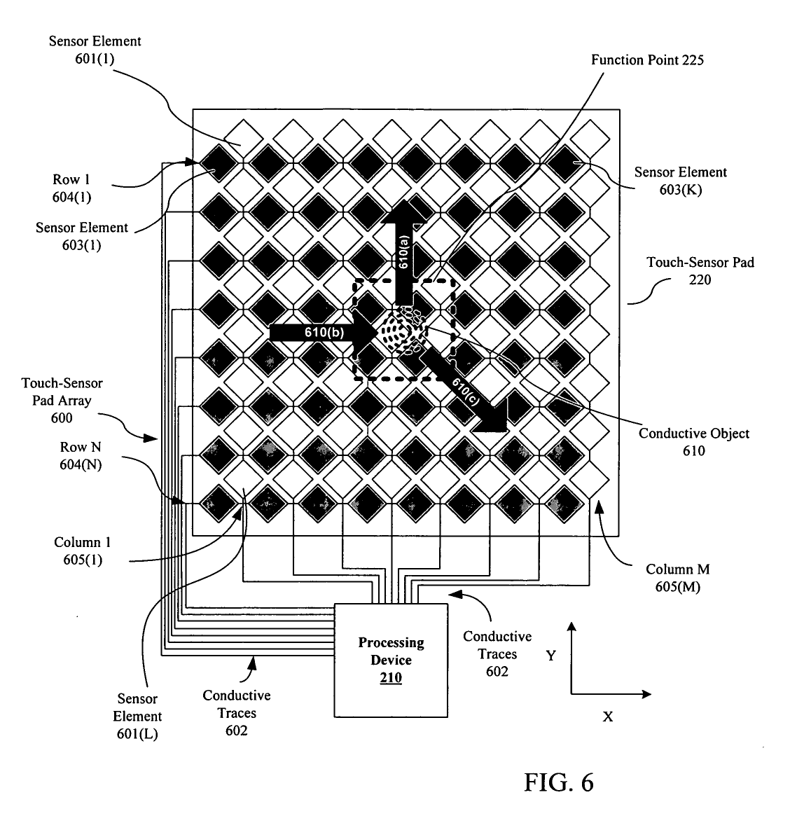

FIG. 6 illustrates a top-side view of an embodiment of a touch-sensor device including a function point 225. In one embodiment, a sensor array of sensor elements of touch-sensor pad 220 includes a function point 225. Beneficially, in one embodiment, as will be discussed in greater detail below, multiple functions can be provided by a touch-sensor pad with a function point without sacrificing surface area of the touch-sensor pad.

Touch-sensor pad 220 includes a first area comprising touch-sensor pad array 600. Touch sensor pad array 600 includes a plurality of rows 604(1)-604(N) and a plurality of columns 605(1)-605(M), where N is a positive integer value representative of the number of rows and M is a positive integer value representative of the number of columns. Each row includes a plurality of sensor elements 603(1)-603(K), where K is a positive integer value representative of the number of sensor elements in the row. Each column includes a plurality of sensor elements 601(1)-601(L), where L is a positive integer value representative of the number of sensor elements in the column. Accordingly, touch-sensor pad array 600 is an N×M sensor matrix. The N×M sensor matrix, in conjunction with the processing device 210, is configured to detect an absolute position of a presence of the conductive object in the x-, and y-directions. In one embodiment, as a conductive object moves across touch-sensor pad array 600, processing device 210 is further configured to detect absolute positioning data indicative of the movement of the presence of the conductive object in the x-, and y-directions.

Alternating columns in touch-sensor pad array 600 correspond to x- and y-axis elements. The y-axis sensor elements 603(1)-603(K) are illustrated as black diamonds in FIG. 6, and the x-axis sensor elements 601(1)-601(L) are illustrated as white diamonds in FIG. 6. It should be noted that other shapes may be used for the sensor elements. In another embodiment, the columns and row may include vertical and horizontal bars (e.g., rectangular shaped bars), however, this design may include additional layers in the PCB to allow the vertical and horizontal bars to be positioned on the PCB so that they are not in contact with one another.

In one embodiment, as a conductive object moves across touch-sensor pad array 600, processing device 210 is configured to detect absolute positioning data indicative of movement of the presence of the conductive object in the x-, and y-directions. Processing device 210 is configured to detect data indicative of certain types of movement, including but not limited to, vertical movement, horizontal movement, and diagonal movement. As discussed above, touch-sensor pad array 600 includes column sensor elements 605(1)-605(M) and row sensor elements 604(1)-604(N). In one embodiment, processing device 210 is configured to recognize vertical movement of a conductive object across the touch sensor pad array 600, which is movement primarily across the row sensor elements 604(1)-604(N), with little or no variation in movement across the column sensor elements 605(1)-605(M). Processing device 210 is also configured to recognize horizontal movement of a conductive object across the touch sensor pad array 600, which is movement across the touch sensor pad array 600 primarily across the column sensor elements 605(1)-605(M), with little or no variation in movement across the row sensor elements 604(1)-604(N). In one embodiment, processing device 210 is further configured to recognize diagonal movement of a conductive object across the touch sensor pad array 600, which is movement across relatively equally numbers of column sensor elements 605(1)-605(M) and row sensor elements 604(1)-604(N) (i.e., movement at an angle across the touch-sensor pad array).

Touch-sensor pad 220 further includes a bounded area that defines function point 225. As noted above, function point 225 may be a non capacitive sensing button, such as physical buttons 270, a touch-sensor button, such as virtual buttons 240, or a combination of both. Although a function point may be implemented by either embodiment, the remainder of the discussion will describe function point 225 as a capacitive sensing button. Processing device 210 is configured to detect an x-/y-position of a presence of conductive object 610 on touch-sensor pad array 600. Then, based on the detected position, processing device 210 compares the x-/y-position with the x- and y-coordinates bounded by function point 225. Based on the result of the comparison, processing device 210 can recognize when a presence of a conductive object is within the area bounded by function point 225.

In one embodiment, processing device 210 utilizes conductive traces 602 for determining a position of a presence of a conductive object 610 on the touch-sensor pad array 600.

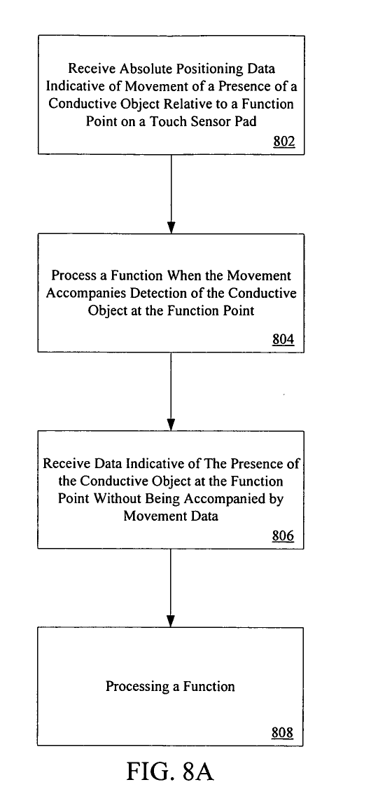

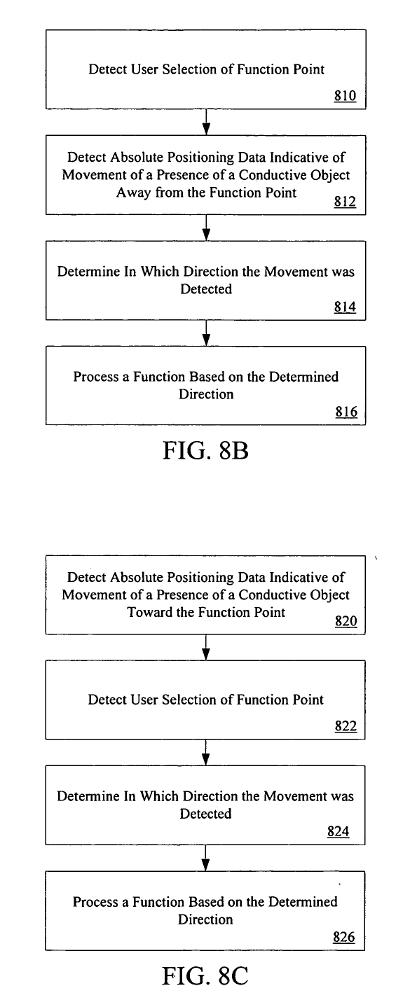

As will be described below, as well as in FIG. 8, touch-sensor pad 220 including a function point 225 may be a multi-function touch-sensor pad utilized to trigger a plurality of operations. In one embodiment, movement of a conductive object across touch-sensor pad 220 in either the vertical, horizontal, or diagonal direction that accompanies a user's selection of function point 225, causes an operation to be performed by processing device 210. In one embodiment, the presence of a conductive object within the area bounded by function point 225, which is unaccompanied by movement, also causes an operation to be performed by processing device 210.

In one embodiment, movement of a conductive object 610 may originate within function point 225 before moving away from function point 225. One example of such movement is illustrated by arrow 610(a) where movement of a presence of a conductive object 610 originated within function point 225, and moves across touch-sensor pad array 600 in a direction that is vertical relative to function point 225. As noted above, processing device 210 recognizes movement primarily across the row sensor elements 604(1)-604(N), with little or no variation in movement across the column sensor elements 605(1)-605(M). In one embodiment, processing device responds by processing a vertical scroll operation. Vertical movement, however, is not the only movement that originates within function point 225. In one embodiment, a presence of a conductive object could originate within function point 225 and move across touch-sensor pad array 600 in a horizontal direction. Such movement may cause processing device to perform a horizontal scroll operation. As such, a processing device of one embodiment is configured to perform vertical scroll up, vertical scroll down, horizontal scroll right, and horizontal scroll left when movement of a conductive object originates within function point 225 and moves in a specific direction away from the function point, but relative to the function point.

In one embodiment, movement of a conductive object which originates within function point 225 and terminates outside of the function point, such as movement 610(c), causes processing device 210 to process additional operations. The operations triggered by a diagonal movement which originates within function point 225 could include, for example, browser function such as browser forward or browse backwards. Similarly, in one embodiment, additional functions could be triggered when a presence of a conductive object, such as presence 610 moves across touch-sensor pad array and the movement terminates within function point 225, as illustrated by arrow 610(b).

However, the operations triggered by a multi-function touch-sensor pad 220 including a function point 225 need not be limited to the operations discussed above. Movement which either originates in or terminates in function point 225 could trigger operations such as volume adjustment, contrast adjustment, etc.

In one embodiment, data indicative of a presence of conductive object 610 may be detected, by processing device 210, within function point 225, without being accompanied by movement. The presence, unaccompanied by movement, would cause processing device 210 to process additional functions. The function could be any of a program start, program end, shortcut, etc. Any operation that can be processed on a notebook system, mobile station, PDA, etc. may be triggered by presence 610. Presence of conductive object 610, alone, may not be enough to cause an operation to be processed. In one embodiment, a tap gesture within function point 225, corresponding to a single-click, is used to trigger an operation. In another embodiment, a double tap gesture or a linger gesture within function point 225 causes either the same or a different operation to be processed by processing device 210. Although presence and tap gestures are described as ways to cause a function to be triggered or processed, other gestures may be utilized to trigger and/or process functions, such as touch gestures.

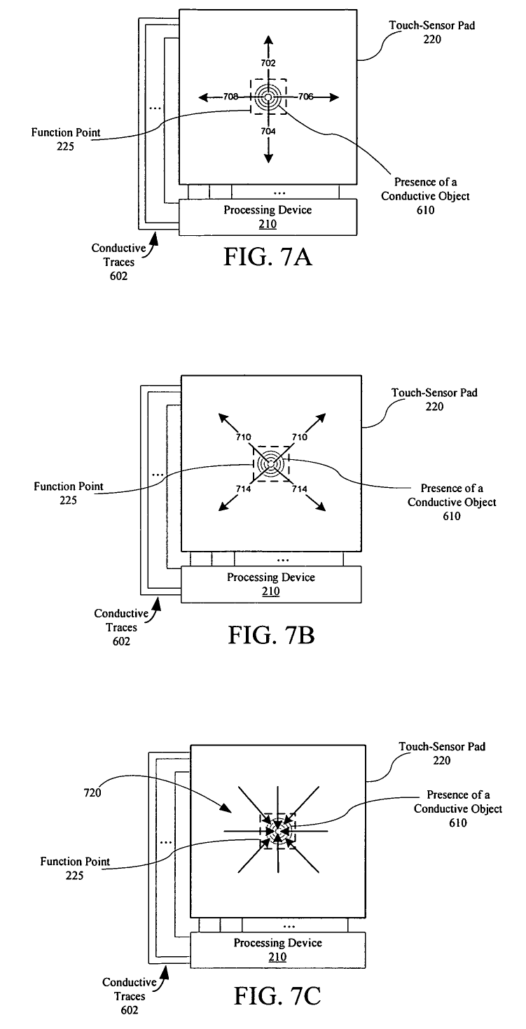

FIGS. 7A-7C illustrate embodiments of a touch-sensor device including a function point. Details corresponding to sensor arrays and sensor elements have been omitted from FIGS. 7A-7C to avoid obscuring the features, similarities, and differences of the described embodiments. However, the elements are more fully discussed above. As illustrated in FIGS. 7A-7C advanced functions are supported by a touch sensor pad including a function point. Beneficially, the functions are realized without dedicating space on a touch sensor pad for regions dedicated to scroll operations, corner functions, browser functions etc.

FIG. 7A illustrates an exemplary embodiment of a touch-sensor pad 220 including a function point 225, as described in FIG. 6. Function point 225 is disposed within a region of touch-sensor pad 220 configured to provide absolute positioning data of a conductive object to processing device 210. As illustrated in FIG. 7A, movement of a conductive object 610 that originates within function point 225, and thereafter moves out of the function point 225, may be movement vertically up 702, vertically down 704, horizontally left 708, or horizontally right 706. A processing logic (discussed in greater detail below) of processing device 210 processes a scroll up operation 702, a scroll down operation 704, a scroll left operation 708, and a scroll right operation 706 corresponding to the direction of horizontal and vertical movement of a conductive object relative to function point 225. The noted operations are not the only operations which may accompany movements 702-708, as one skilled in the art will appreciate additional and/or different operations which could be triggered by movements 702-708.

FIG. 7B illustrates another exemplary embodiment of a touch-sensor pad 220 including a function point. However, instead of vertical and horizontal movement of a conductive object, FIG. 7B illustrates movement of a conductive object 610 that originates within function point 225, and thereafter moves out of the function point 225, in either a diagonally up 710 direction or a diagonally down 710 direction. In one embodiment, processing logic (not shown) of processing device 210 processes a forward browse operation 710 and a backwards browse operation 714 corresponding to the direction of diagonal movement of conductive object 610 relative to function point 225.

As illustrated in FIGS. 7A and 7B, a touch-sensor pad 220 may include operations triggered by various directions of movement of a conductive object originating within a function point, and then moving out of the function point. In another exemplary embodiment, as illustrated in FIG. 7C, movement 720 of a conductive object 610 which terminates within the area defined by function point 225 (e.g., movement that begins outside function point 225 and moves across touch-sensor pad 220 into the area defined by function point 225), further causes processing logic to process one of a plurality of operations based on the direction of movement of conductive object 610. The operations processed by processing logic may include any of the operations discussed above, as well as additional operations, which can be appreciated by one skilled in the art.

FIG. 8A illustrates one embodiment of a method for processing data received from a touch sensor pad including a function point. The method may be implemented by processing logic that may be embodied in hardware (circuitry, dedicated logic, etc.), software (such as is run on a general purpose computer system or a dedicated machine), or a combination of both. Furthermore, the hardware, software, or combination of both may be embedded in one or more of processing device 210, embedded controller 260, and host 250.

In this embodiment, the method begins when processing logic receives absolute positioning data indicative of movement of a presence of a conductive object relative to a function point on a touch sensor pad, step 802. The movement received by processing logic is movement in one of a plurality of directions such as vertical, diagonal, horizontal, etc. In one embodiment, the function point is a capacitive sensing element comprising a virtual button. In another embodiment, the function point is a physical button. In either embodiment, the function point is disposed within a region of the touch sensor pad that is configured to provide processing logic with absolute positioning data.

When the movement, detected in step 802, accompanies detection of the conductive object at the function point, processing logic processes a function, step 804. Next processing logic receives data indicative of the presence of the conductive object at the function point without being accompanied by movement data, step 806, and processes a corner function, step 808. In one embodiment, for example, a corner function may cause processing logic to open a shortcut menu, launch an application, close an application, etc.

FIG. 8B illustrates one embodiment of a method for processing data received from a touch sensor pad including a function point. The method may be implemented by processing logic that may be embodied in hardware (circuitry, dedicated logic, etc.), software (such as is run on a general purpose computer system or a dedicated machine), or a combination of both. Furthermore, the hardware, software, or combination of both may be embedded in one or more of processing device 210, embedded controller 260, and host 250.

In this embodiment, the method begins when processing logic detects data indicative of a selection by a user of a function point of a touch sensor pad, step 810. Then, after detecting data indicative of the selection of the function point, processing logic detects absolute positioning data indicative of a movement of a presence of a conductive object across the touch sensor pad, step 812. That is, processing logic detects movement of a conductive object that originates within a function point, as indicated by the selection, and thereafter detects movement of the conductive object across the touch-sensor pad away from the function.

The direction in which the movement is detected is then determined by processing logic, step 814. As discussed above, the direction of movement may be any one of a plurality of directions, including but not limited to, movement away from the function point in a vertical, horizontal, or diagonal direction. Processing logic then processes a function, such as a scroll function or a browser function, based on the determined direction, step 816.

FIG. 8C illustrates one embodiment of a method for processing data received from a touch sensor pad including a function point. The method may be implemented by processing logic that may be embodied in hardware (circuitry, dedicated logic, etc.), software (such as is run on a general purpose computer system or a dedicated machine), or a combination of both. Furthermore, the hardware, software, or combination of both may be embedded in one or more of processing device 210, embedded controller 260, and host 250.

In this embodiment, the method begins when processing logic detects absolute positioning data indicative of a movement of a presence of a conductive object toward the touch sensor pad, step 820, before detecting a user selection of the function point. Processing logic then detects data indicative of a selection by a user of the function point of the touch sensor pad, step 822. That is, processing logic detects movement of a conductive object that terminates within a function point, as indicated by movement that terminates with the selection of the function point. The direction in which the movement was detected is then determined by processing logic, step 824. As discussed above, the direction of movement may be any one of a plurality of directions, including but not limited to, movement towards the function point in a vertical, horizontal, or diagonal direction. Processing logic then processes a function based on the determined direction, step 826.

While some specific embodiments of the invention have been shown, the invention is not to be limited to these embodiments. The invention is to be understood as not limited by the specific embodiments described herein, but only by scope of the appended claims.

What is claimed is:

1. A method, comprising:
receiving absolute positioning data indicative of movement of a presence of a conductive object across a touch sensor pad in one of a plurality of directions relative to a function point, wherein the function point is at least one of a physical button or a virtual button of the touch sensor pad disposed in a region of the touch sensor pad configured to receive absolute positioning data;
processing a function when the movement accompanies detection of the conductive object at the function point.

2. The method of claim 1, wherein the processing a function when the movement accompanies detection of the conductive object at the function point further comprises:
detecting data indicative of a selection by a user of the function point of the touch sensor pad;
detecting absolute positioning data indicative of a movement of a presence of a conductive object, across the touch sensor pad, away from the function point, after detecting data indicative of the selection by the user of the function point;
determining in which direction the movement is detected; and
processing the function based on which direction the movement was determined.

3. The method of claim 2, wherein the function is a scroll function when the direction is determined to be one of a vertical or a horizontal direction across the touch sensor pad.

4. The method of claim 2, wherein the function is a browser function when the direction is determined to be a diagonal direction across the touch sensor pad.

5. The method of claim 1, wherein the processing a function when the movement accompanies detection of the conductive object at the function point further comprises:
detecting absolute positioning data indicative of a movement of a presence of a conductive object, across the touch sensor pad, toward the function point of the touch sensor pad;
detecting data indicative of a selection by a user of the function point of the touch sensor pad, after detecting data indicative of the movement of the presence of the conductive object;
determining in which direction the movement was detected; and
processing the function based on which direction the movement was detected.

6. The method of claim 1, further comprising:
receiving data indicative of the presence of the conductive object at the function point without being accompanied by movement of the presence of the conductive object across the touch sensor pad; and
processing a corner function.

7. The method of claim 1, wherein the area defined by the function point of the touch sensor pad is visually distinguished on the touch sensor pad.

8. The method of claim 1, wherein the area defined by the function point of the touch sensor pad is physically distinguished on the touch sensor pad.

9. The method of claim 1, wherein the absolute positioning data indicative of movement of a presence of a conductive object is input data for the function.

10. An apparatus, comprising:
a touch sensing device having a touch sensor pad and a function point, wherein the function point is at least one of a physical button or a virtual button of the touch sensor pad disposed in a region of the touch sensor pad configured to receive absolute positioning data; and
a processing logic coupled with the touch sensing device, the processing logic to:
receive absolute positioning data indicative of movement of a presence of a conductive object across a touch sensor pad in one of a plurality of directions relative to a function point;
process a function when the movement accompanies detection of the conductive object at the function point.

11. The apparatus of claim 10, wherein the processing logic to process a function when the movement accompanies detection of the conductive object at the function point further comprises:
the processing logic to:
detect data indicative of a selection by a user of the function point of the touch sensor pad;
detect absolute positioning data indicative of a movement of a presence of a conductive object, across the touch sensor pad, away from the function point, after data indicative of the selection by the user of the function point is detected;
determine in which direction the movement is detected; and
process the function based on which direction the movement was determined.

12. The apparatus of claim 11, wherein the function is a scroll function when the direction is determined to be one of a vertical or a horizontal direction across the touch sensor pad.

13. The apparatus of claim 12, wherein the function is a browser function when the direction is determined to be a diagonal direction across the touch sensor pad.

14. The apparatus of claim 10, wherein the processing logic to process a function when the movement accompanies detection of the conductive object at the function point further comprises:
the processing logic to:
detect absolute positioning data indicative of a movement of a presence of a conductive object, across the touch sensor pad, toward the function point of the touch sensor pad;
detect data indicative of a selection by a user of the function point of the touch sensor pad, after data indicative of the movement of the presence of the conductive object is detected;
determine in which direction the movement was detected; and
process the function based on which direction the movement was detected.

15. The apparatus of claim 10, further comprising:
the processing logic to:
receive data indicative of the presence of the conductive object at the function point without being accompanied by movement of the presence of the conductive object across the touch sensor pad; and
processing a corner function.

16. The apparatus of claim 10, wherein the area defined by the function point of the touch sensor pad is visually distinguished on the touch sensor pad.

17. The apparatus of claim 10, wherein the area defined by the function point of the touch sensor pad is physically distinguished on the touch sensor pad.

18. The apparatus of claim 10, wherein the absolute positioning data indicative of movement of a presence of a conductive object is input data for the function.

19. An apparatus, comprising:
means for receiving absolute positioning data indicative of a movement of a conductive object across a touch sensor pad; and
means for processing a function based on the absolute positioning data indicative of the movement of the conductive object when the movement originates or terminates in a region of the touch sensor pad, the region disposed within an area of the touch sensor pad for receiving absolute positioning data.

20. The apparatus of claim 19, wherein the means for processing the function further comprising:
means for processing a first type of function when the movement of the conductive object originates in the region of the touch sensor pad; and
means for processing a second type of function when the movement of the conductive object terminates in the region of the touch sensor pad.
